(19) United States
(12) Patent Application Publication
(10) Pub. No.: US 2008/0106124 A1
(43) Pub. Date: May 8, 2008

(54) ROOF MODULE FOR VEHICLE

(75) Inventor: Darin J. Snider, Holland, MI (US)

Correspondence Address: VAN DYKE, GARDNER, LINN & BURKHART, LLP, SUITE 207, 2851 CHARLEVOIX DRIVE, S.E., GRAND RAPIDS, MI, 49546, US

(73) Assignee: Donnelly Corporation, Holland, MI (US)

(21) Appl. No.: 11/933,699

(22) Filed: Nov. 1, 2007

Related U.S. Application Data
(60) Provisional application No. 60/874,695, filed on Dec. 13, 2006.
(60) Provisional application No. 60/856,538, filed on Nov. 3, 2006.

(51) Int. Cl. B62D 25/06

(52) U.S. Cl. 296/215

(57) ABSTRACT

A vehicle glass roof module is provided by assembling a vehicle at a vehicle assembly plant and attaching a roof portion that is adapted to provide a perimeter mounting portion for mounting the glass roof module thereto. The roof portion includes a front header portion and a rear header portion and a glass panel mounting portion or trough at each of the header portions. The assembled vehicle may be water tested at the vehicle assembly plant, with the roof portion attached thereto. The assembled vehicle may be transported to an external provider for installing the glass roof module, where a center roof panel portion of the roof portion is removed by cutting the roof portion at or near the mounting portions or troughs. A glass roof module having a glass roof panel is set onto the mounting portions or troughs and is attached to the mounting portions or troughs.

### CROSS REFERENCE TO RELATED APPLICATIONS

The present application claims benefit of U.S. provisional applications, Ser. No. 60/856,538, filed Nov. 3, 2006, and Ser. No. 60/874,695, filed Dec. 13, 2006, which are hereby incorporated herein by reference in their entireties.

### FIELD OF THE INVENTION

The present invention relates to a window assembly for a vehicle and, more particularly, a window assembly that provides a glass roof for a vehicle.

### BACKGROUND OF THE INVENTION

Vehicle assembly plants manufacture and assemble many vehicles each day. It is desirable to provide an efficient assembly process for assembling the vehicles as they move along the assembly line. When a fully assembled vehicle is completed, it must pass a water test before being shipped from the assembly plant. Some vehicles are manufactured by the assembly plant and then moved off-line (such as to another location at the vehicle manufacturer or to an external provider) for installing a niche option, such as a convertible top or a vista roof, because such options are most economically satisfied off-line or remote from the vehicle assembly line.

### SUMMARY OF THE INVENTION

The present invention provides a glass roof assembly or module that includes a glass (or other suitable material, such as polycarbonate or the like) roof panel that is attached to the vehicle sheet metal to provide substantially continuous glass panels including the vehicle windshield, the glass roof panel and the vehicle rear window or backlite.

According to an aspect of the present invention, a glass roof assembly or module includes a glass roof panel and one or more frame portions for mounting or attaching the roof panel to the vehicle sheet metal. The roof module may be attached to the vehicle sheet metal via any suitable adhesive or bonding material or fasteners.

Optionally, the glass roof module may include a header portion at the front and/or rear of the glass roof panel to span a gap or gaps between the glass roof panel and the vehicle windshield and/or backlite. Optionally, the roof module may be configured or adapted to be received in an opening cut or formed through the existing vehicle roof. Optionally, the glass roof panel of the roof module may extend substantially between the upper region of the vehicle windshield to the upper region of the vehicle backlite to provide substantially continuous glass along the cabin of the vehicle.

Optionally, the roof module may include a shade or screen device that is selectively extendable/retractable to shade or partially shade the roof panel.

These and other objects, advantages, purposes and features of the present invention will become apparent upon review of the following specification in conjunction with the drawings.

### BRIEF DESCRIPTION OF THE DRAWINGS

FIG. 1 is a perspective view of a vehicle with a glass roof assembly or module in accordance with the present invention;

FIGS. 2-4 are sectional views of a vehicle with a conventional sheet metal roof;

FIGS. 5-7 are sectional views of a vehicle with the roof cut away and with a glass roof assembly attached to the vehicle;

FIGS. 8-10 are sectional views of a vehicle with no roof installed thereto, and with a glass roof assembly attached to the vehicle;

FIG. 11 is a perspective view of a vehicle with a glass roof assembly or module in accordance with the present invention;

FIG. 12 is an exploded perspective view of the vehicle of FIG. 11;

FIG. 13 is an exploded perspective view of a glass roof assembly or module of the present invention;

FIG. 14 is a perspective view of a glass panel having attachment elements attached thereto;

FIG. 15 is a perspective view of the glass panel of FIG. 14, with a sun screen module attached thereto;

FIG. 16 is a perspective view of a roof panel for attaching to a vehicle in the vehicle assembly plant in accordance with the present invention;

FIG. 16A is an enlarged perspective view of a corner of the roof panel of FIG. 16;

FIG. 17 is a perspective view of the roof panel of FIG. 16 as installed at a vehicle in the vehicle assembly plant;

FIG. 18 is a sectional view of the glass roof assembly or module of the present invention, taken along the front header portion of the glass roof assembly or module;

FIG. 19 is a sectional view of the glass roof assembly or module of the present invention, taken along the rear header portion of the glass roof assembly or module;

FIG. 20 is a sectional view of the glass roof assembly or module of the present invention, taken along one of the sides of the glass roof assembly or module;

FIG. 21 is an exploded perspective view of another glass roof assembly or module of the present invention; and

FIGS. 22-24 are sectional views of a vehicle with the glass roof module of FIG. 21 attached thereto.

### DESCRIPTION OF THE PREFERRED EMBODIMENTS

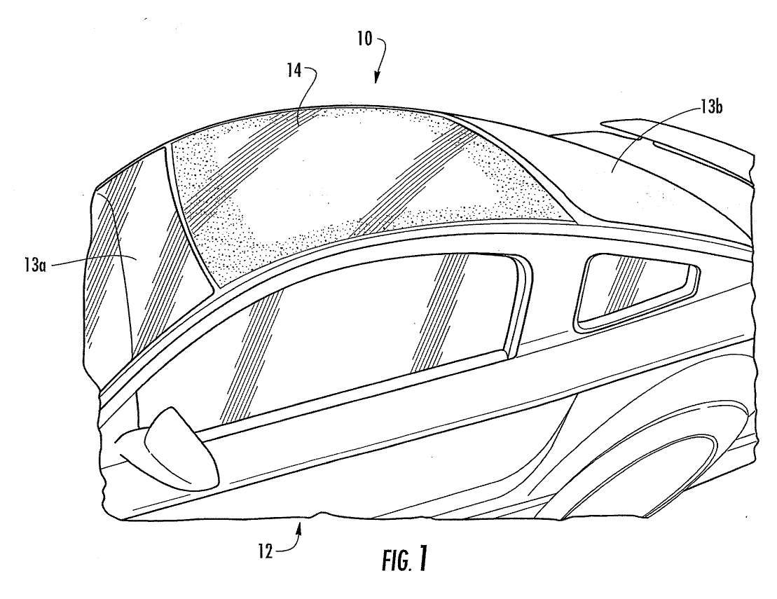

Referring now to the drawings and the illustrative embodiments depicted therein, a glass roof assembly or module 10 is mounted to or attached to a vehicle 12 and includes a glass panel 14 that is attached at or near the vehicle windshield 13a and backlite 13b (FIG. 1). The glass roof panel 14 may be bonded or attached to the vehicle sheet metal, or a frame portion of the roof module may be bonded or otherwise secured or fastened to the vehicle sheet metal (such as the header reinforcements 12a, 12b at the forward and rearward portions of the vehicle roof area and/or body side reinforcements 12c at the sides of the vehicle roof area), to attach and seal the roof module to the vehicle.

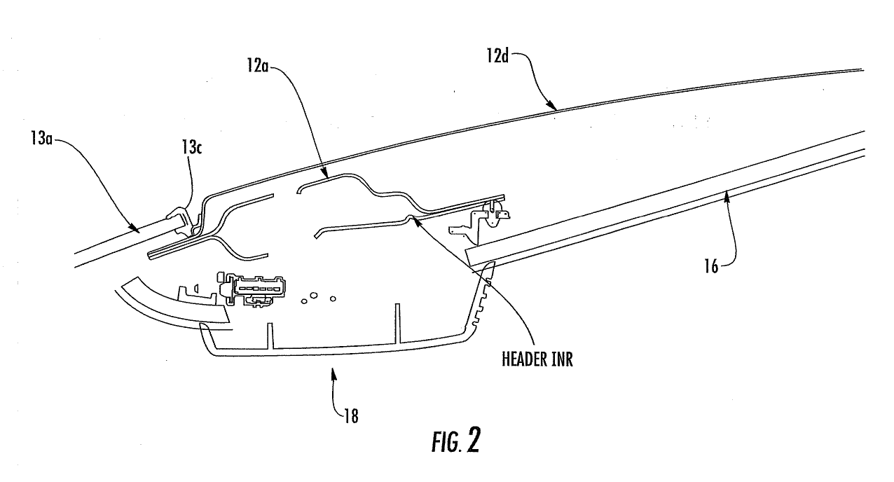

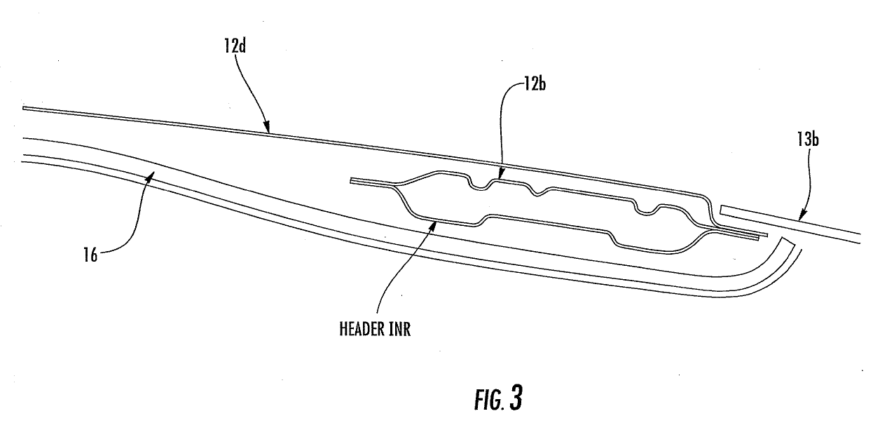

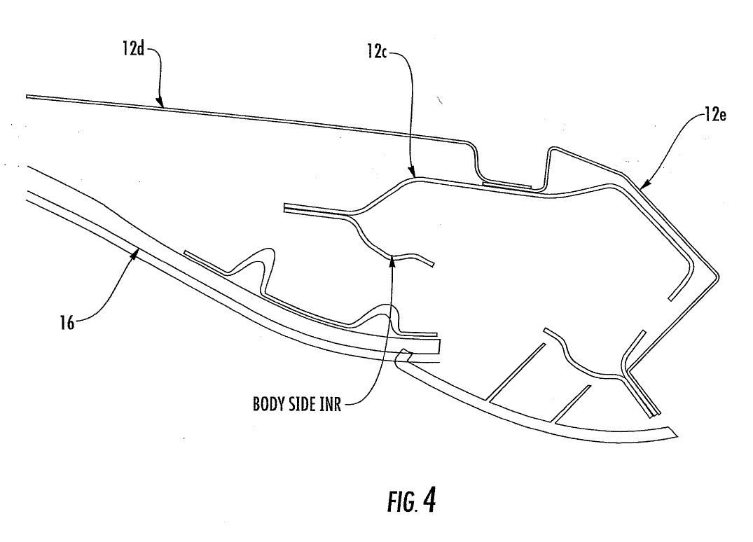

As shown in FIGS. 2-4, a typical vehicle has a roof or roof panel 12d, which may comprise a sheet metal roof panel or the like. The roof panel 12d is attached at a forward portion of the header reinforcement member 12a (FIG. 2) at the front of the vehicle roof area and at a rear portion of a rear header reinforcement member 12b (FIG. 3) at the rear of the vehicle roof area. As can be seen in FIGS. 2 and 3, the roof panel 12d is configured such that an upper edge of the windshield 13a is mounted or received at a channel or recess at the forward edge of the roof panel 12d and such that an upper edge of the rear window or backlite 13b is mounted or received at a channel or recess at the rearward edge of the roof panel 12d. A trim element or sealing element 13c may be provided at the upper edge of the windshield to substantially seal the junction between the upper edge of the windshield and the forward edge or region of the roof panel. Similarly, the side edges of the roof panel 12d may be mounted to a side reinforcement member 12c, which may also have the body side outer sheet metal 12e attached thereto, such as shown in FIG. 4.

The interior surface of the roof panel is covered or concealed by a headliner 16 that covers or conceals the roof panel and the header reinforcements at the roof or ceiling of the vehicle cabin. Optionally, the vehicle may include an overhead console or header trim element or panel 18, such as at a forward area of the cabin ceiling.

In situations where it may be desirable to provide a vista roof or glass roof on a vehicle, the vehicle may be manufactured and assembled at a vehicle assembly plant or facility, and then moved or shipped to another location (either another location at the vehicle assembly facility or to another location of the vehicle manufacturer or to another location of a remote or external source or provider) for attachment of the glass roof. Although the vehicle may be manufactured initially with the glass roof, this is often not the preferred approach, since the number of vehicles to be made with such an optional glass roof is typically small, and thus would add parts and different assembly processes to the assembly plant, which is undesirable.

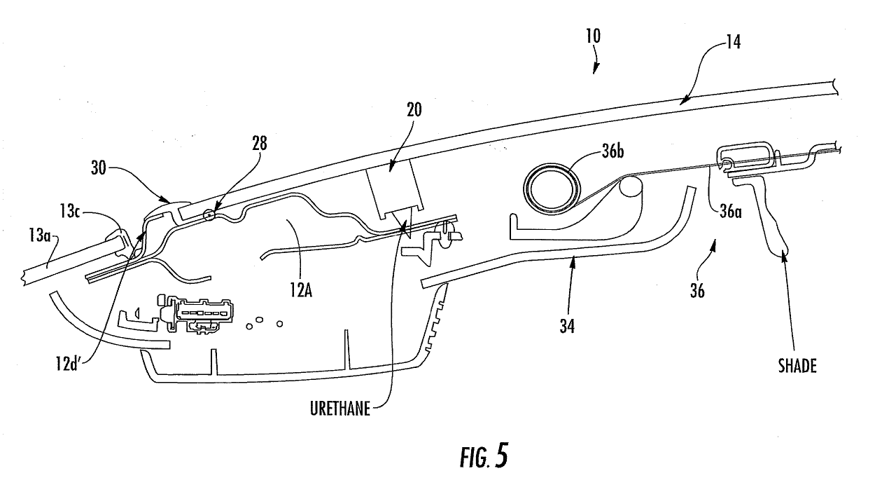

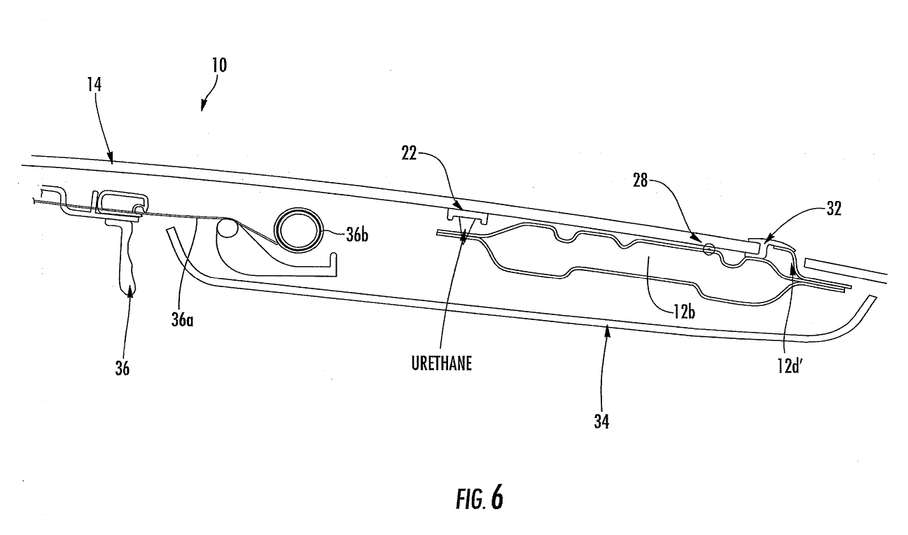

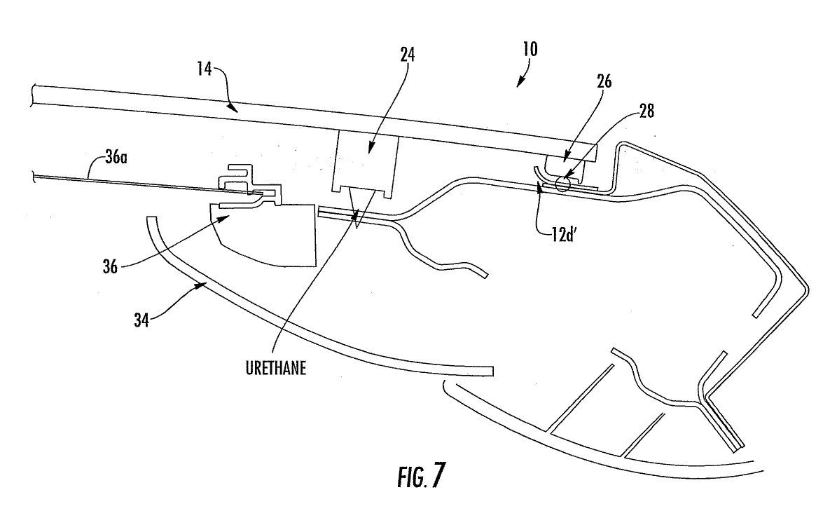

Optionally, the vehicle may be manufactured and assembled in its typical manner with a sheet metal roof panel, such as described above, and then the roof panel may be cut or removed at a later time so that the vehicle may be retrofitted with a glass roof panel. For example, and with reference to FIGS. 5-7, a central region of the roof panel may be cut or removed, leaving a perimeter roof portion 12d′ around the perimeter of the roof area. A glass roof assembly 10 may be configured to be received within the opening formed in the existing roof of a vehicle, whereby the cut roof or cut roof portion 12d′ provides a perimeter roof portion or support for the roof assembly 10 at the roof area of the vehicle. As shown in FIGS. 2-4, the roof assembly 10 includes a roof glass panel 14 that is attached to the vehicle reinforcement members 12a, 12b, 12c, and may be generally flush with the edges of the cut roof 12d′ (such as shown in FIGS. 5 and 6) or may overlap the cut roof edge (such as shown in FIG. 7).

Glass roof assembly 10 includes a forward inner module or member 20, which may be encapsulated or bonded to the inner surface of the panel 14 and adhered or attached to the reinforcement member 12a of the vehicle 12. Similarly, the roof assembly includes a rearward inner module 22, which may be encapsulated or bonded to the inner surface of the panel 14 and adhered or attached to the reinforcement member 12b of the vehicle. A side inner module or member 24 may be provided at panel 14 for attaching the panel to the side reinforcement member 12c, while a side outer module or member 26 may be provided at the outer side perimeter region of the panel for attaching or sealing the panel 14 at the side regions of the cut roof portion 12d′. The glass panel 14 thus is attached or adhered to the vehicle via inner module members 20, 22, 24 that space the glass from the reinforcement members to limit or reduce glass breakage during use and operation of the vehicle. A sealant or butyl seal or bead or tape 28 may be provided at least partially around the perimeter region of the glass roof panel 14 to seal the panel 14 to the respective reinforcement members 12a, 12b (such as shown in FIGS. 5 and 6) and/or to the cut roof portion 12d′ (such as shown in FIG. 7).

In the illustrated embodiment, roof assembly 10 includes a forward molding 30 along its forward edge for engaging and overlapping the forward edge of the cut roof 12d′ at or near the vehicle windshield 13a, and may include a rearward molding 32 along its rearward edge for engaging and overlapping the rearward edge of the cut roof 12d′ at or near the vehicle backlite 13b. A new headliner portion 34 may be provided at the forward, rearward and side regions to cover or conceal the perimeter regions of the roof module 10″. Optionally, and desirably, roof assembly 10 may include a sun shade module or assembly 36, which includes a screen or shade 36a that is extendable or retractable at a spool 36b to at least partially shade or cover the glass panel 14, such as by utilizing aspects of the sun shade modules of the types described in U.S. patent application Ser. No. 11/243,783, filed Oct. 5, 2005 by Dubay et al. for WINDOW AND SUN SHADE MODULE FOR VEHICLE, and published Apr. 20, 2006 as U.S. Publication No. US-2006-0082192-A1, which is hereby incorporated herein by reference in its entirety, and such as discussed below.

Thus, for example, vehicles designated for a glass roof may be manufactured and assembled at a vehicle assembly plant in the same manner as the other vehicles designated for a hard top or roof. The completed vehicles may then be shipped or moved to another location (such as elsewhere at the vehicle manufacturer or to an external provider or installer), where the external provider may cut away the vehicle roof around a perimeter of the vehicle roof. The roof assembly may be placed at the cut opening (such as described above) and bonded or adhered or attached thereto, whereby the glass roof may abut or may be near or at the windshield and/or rear backlite so as to provide a substantially continuous glass panel at the vehicle (optionally with trim elements at the junctions between the roof panel and the windshield and backlite). Because direct attachment of the glass to the vehicle frame or sheet metal may lead to problems with attaching the glass roof and may lead to breakage of the glass roof, it is desirable to attach the glass roof via the spacers or module members at or near the perimeter regions of the glass roof panel.

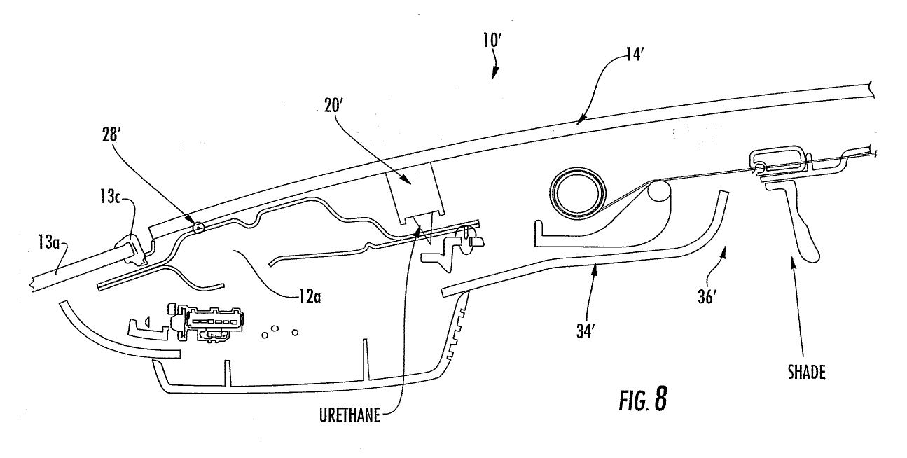

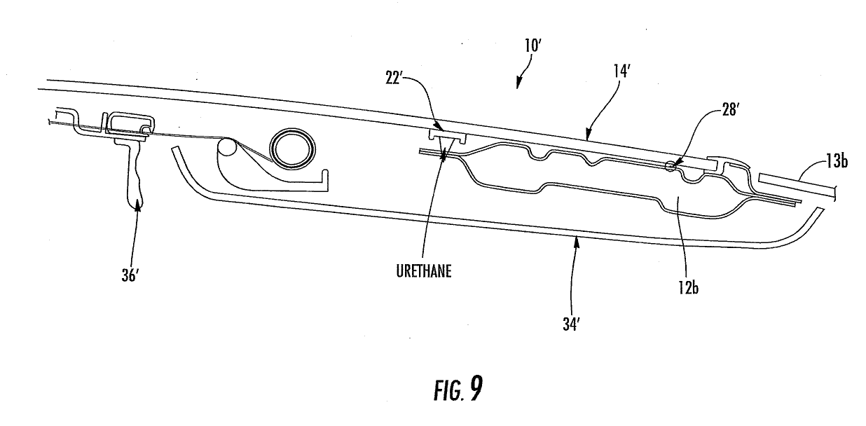

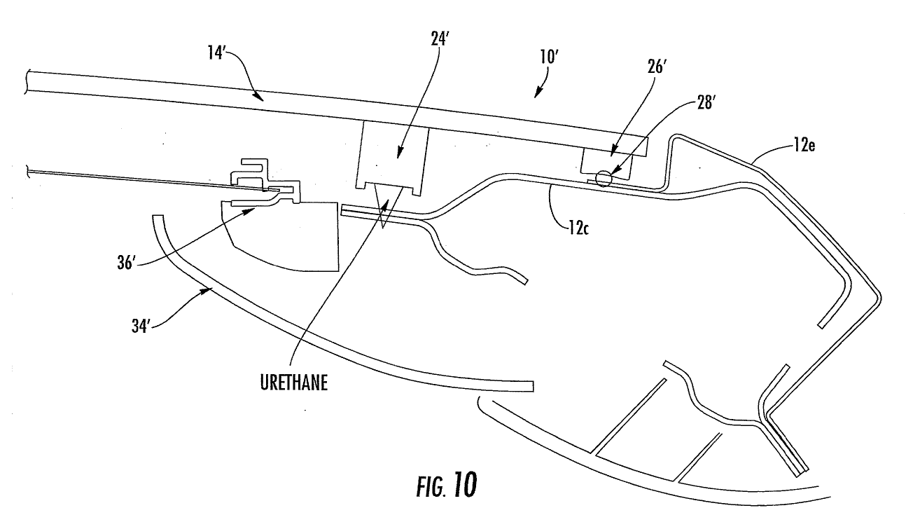

Optionally, the roof module or assembly may be mounted to the frame of a vehicle that is assembled and manufactured without a roof panel. For example, and with reference to FIGS. 8-10, a roof assembly 10′ may be substantially similar to roof assembly 10, discussed above, and may mount to the reinforcement members 12a-c of the vehicle 12, which does not include a roof panel thereon. For example, roof assembly 10′ may include a glass panel 14′ that is bonded or sealed at the vehicle frame or sheet metal and that may include an inner module or member 20′ at the forward region for attaching or adhering or bonding to the reinforcement member 12a of the vehicle at or near the windshield 13a. Likewise, the roof module 10′ may include an inner module or member 22′ at a rearward region for attaching to the reinforcement member 12b of the vehicle, and may include a side inner module or member 24′ along a side region for attaching to the reinforcement member 12c of the vehicle. Optionally, the roof module 10′ may include an outer module or member 26′ at the side regions for attachment and sealing at the side reinforcement member 12c and/or vehicle sheet metal and/or to the body outer side 12e of the vehicle, such as in a similar manner as described above. Optionally, a butyl seal or rope or tape 28′ or the like may be disposed around the perimeter regions of the glass panel 14′ to seal the panel to the reinforcement members and/or vehicle sheet metal, such as in a similar manner as described above. As shown in FIG. 8, the windshield seal 13c may attach and/or seal the windshield at the reinforcement member 12a, and may engage and substantially seal against the forward edge of the roof glass panel 14.

Optionally, the reinforcements at the front or rear of the vehicle and/or at the sides of the vehicle may require modification to adapt the reinforcements for attachment of the glass panel thereto, such as at the transition between the reinforcements and the side pillar, and/or along the reinforcements, such as by providing holes along the reinforcements to accommodate flow of the adhesive or the like. The inner modules 20′, 22′, 24′ may form a perimeter frame of the glass roof panel and may be adhered to the respective sheet metal portions to provide a continuous or substantially continuous attachment and support of the glass roof panel at the vehicle sheet metal. Such a configuration provides substantially continuous glass panels comprising the windshield, roof panel and the rear backlite, without having to cut the roof of the vehicle. A new headliner portion 34′ may be provided at the forward, rearward and side regions to cover or conceal the perimeter regions of the roof module 10′. Optionally, and desirably, the roof module or assembly 10′ may include a sun shade module or assembly 36′, such as discussed below. Although such an approach provides an effective attachment of the roof assembly to the vehicle, it may require that vehicles designated for the glass roof panel be treated and processed differently than vehicles not so designated, which adds processes to the vehicle assembly plant.

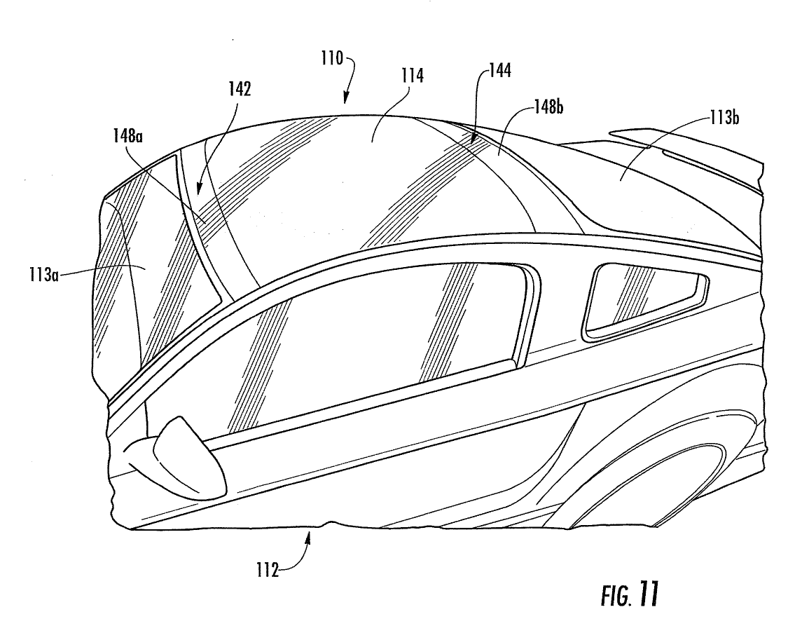

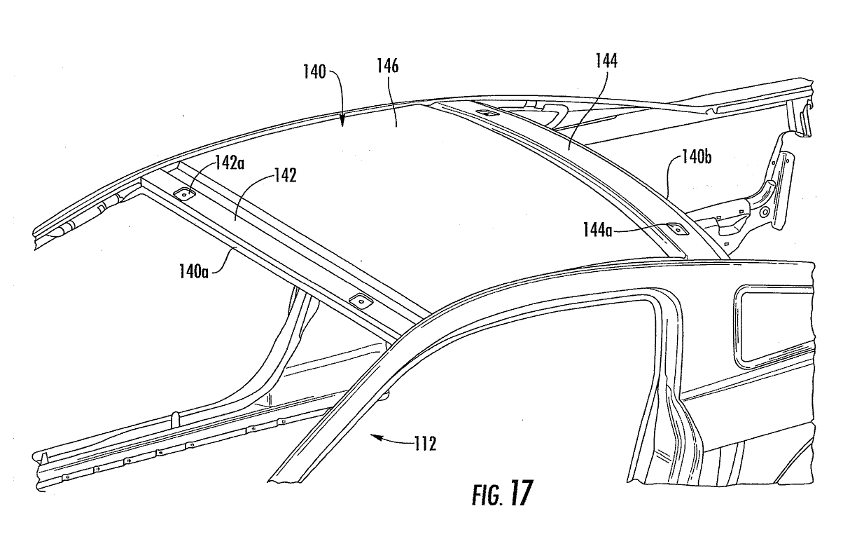

Referring now to FIGS. 11-20, a glass roof module 110 for a vehicle 112 includes a glass panel 114 and a roof portion 140, which includes a forward mounting portion or header portion 142 and a rearward mounting portion or header portion 144, with a temporary center roof portion 146 therebetween. Temporary center roof portion 146 may be cut or otherwise removed from roof portion 140, such as after the vehicle is assembled and at the roof module installation facility, as discussed below. The forward header portion 142 spans a gap between the glass panel 114 and the vehicle windshield 113a and the rearward header portion 144 spans a gap between the glass panel 114 and the rear backlite or rear window 113b of the vehicle 112. The header portions 142, 144 may be welded or bonded or otherwise secured to the vehicle frame or sheet metal at the upper region of the windshield and at the upper region of the rear backlite, respectively, such as at the vehicle assembly plant. The header portions may be selected to color match the vehicle body or may be black or other neutral color, or an appliqué 148a, 148b or the like may be attached to the header portions 142, 144 to provide the desired exterior appearance, depending on the particular application and desired appearance, as discussed below.

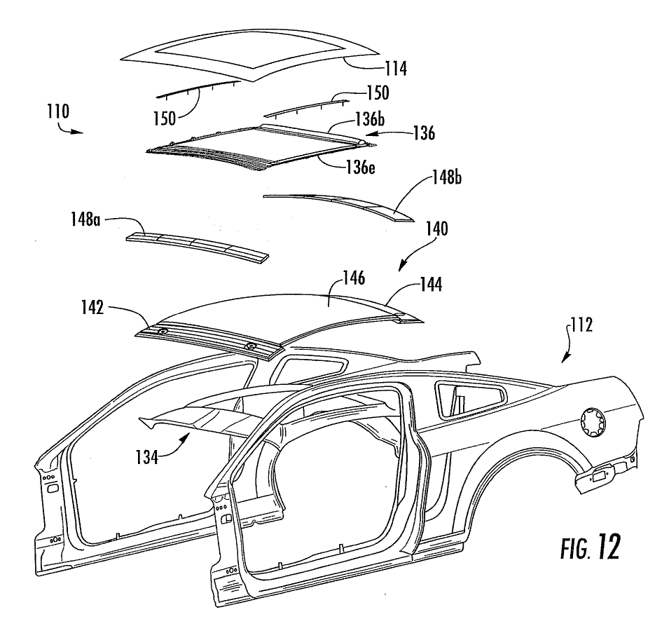

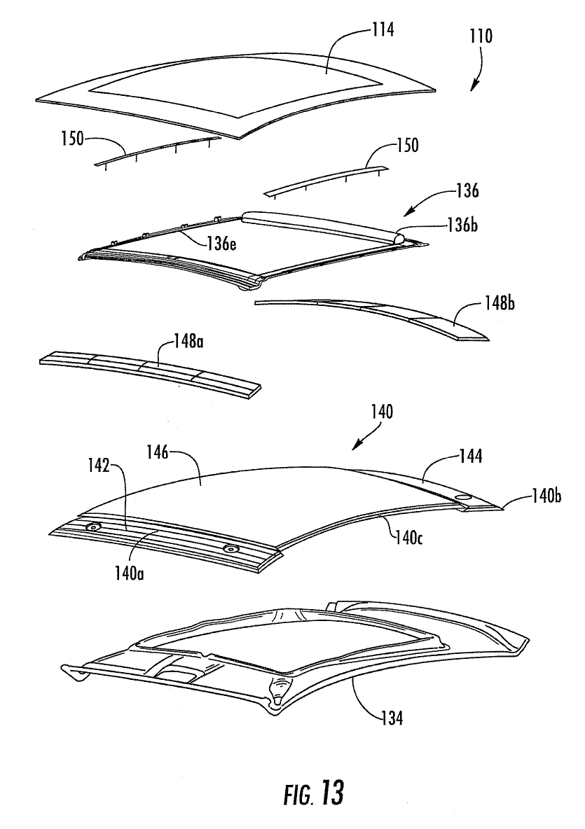

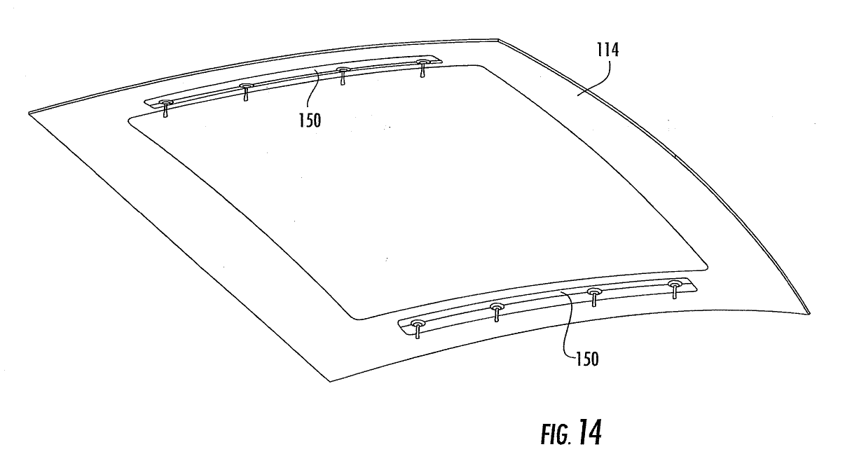

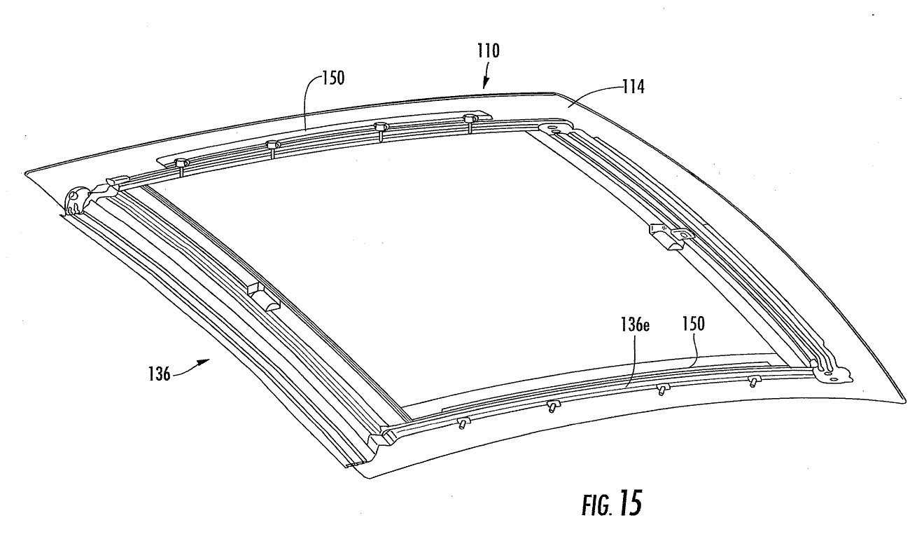

In the illustrated embodiment, and as shown in FIGS. 12 and 13, roof module 110 includes glass panel 114 and sun shade assembly or module 136, which is attached to glass panel 114 via fasteners or attachment elements 150. In the illustrated embodiment, attachment elements 150 comprise a pair of stud strips that are adhered or bonded to the lower or interior surface of the glass panel 114 and along its side regions (such as shown in FIG. 14), whereby the sun shade module 136 may receive the studs and may attach to the studs (such as shown in FIG. 15), such as via female fasteners or the like. However, other attachment elements or attachment means may be used to attach the sun shade module to the glass roof panel 114, while remaining within the spirit and scope of the present invention.

As shown in FIGS. 12, 13, 16 and 17, the roof panel 140 is mountable or attachable to the vehicle frame, such as in a similar manner as described above with respect to roof panel 12d. The roof panel 140 is formed to provide the front mounting portion or header portion 142 and the rear mounting portion or header portion 144 at the forward and rearward regions of the roof panel, respectively. Roof panel 140 includes a central roof panel portion 146 that provides a temporary roof for the vehicle at the vehicle assembly plant. The temporary central roof panel portion 146 may be cut or otherwise removed from the roof panel 140 and the vehicle 112 when the glass roof module 110 is to be installed at the vehicle, as discussed below. Thus, the vehicle may be manufactured and assembled at a vehicle assembly plant and may have a roof attached thereto, whereby the vehicle may undergo the usual water tests and paint processes of other vehicles in the assembly plant. Thus, vehicles at the assembly plant that are designated for the glass roof module are assembled and processed in substantially the same manner as vehicles designated for the conventional hard top or roof, with the only exception being that a different roof panel is attached to the differently designated vehicles.

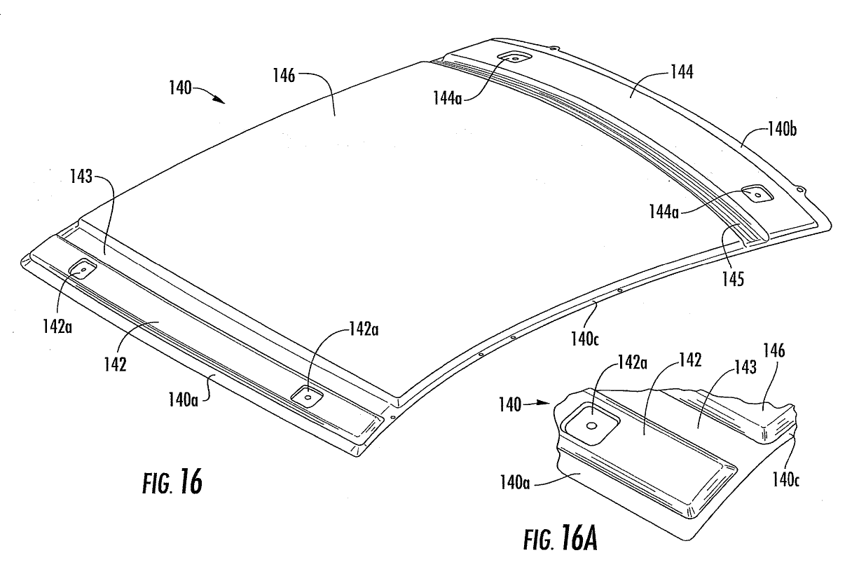

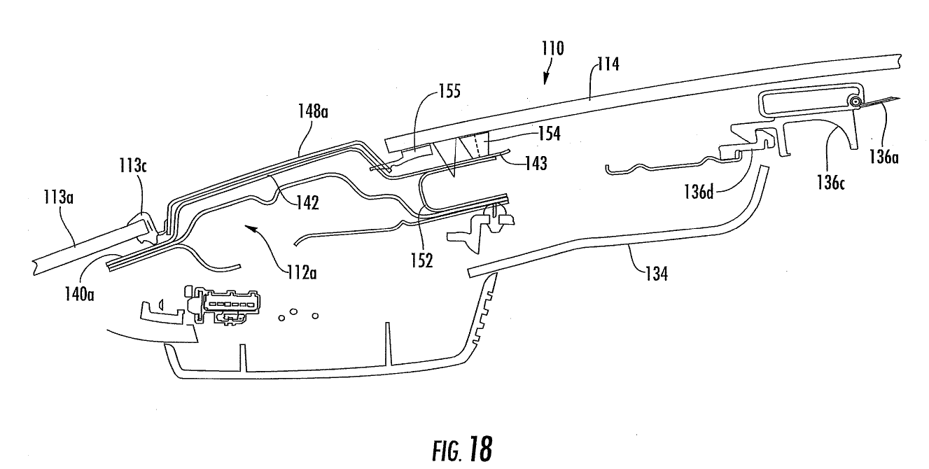

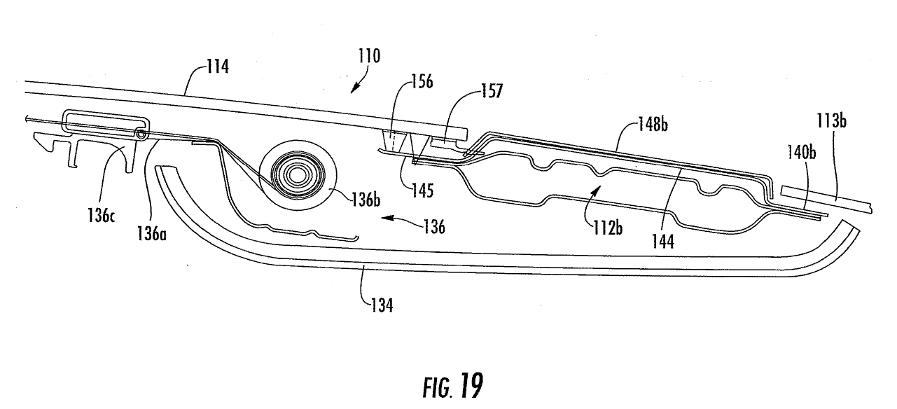

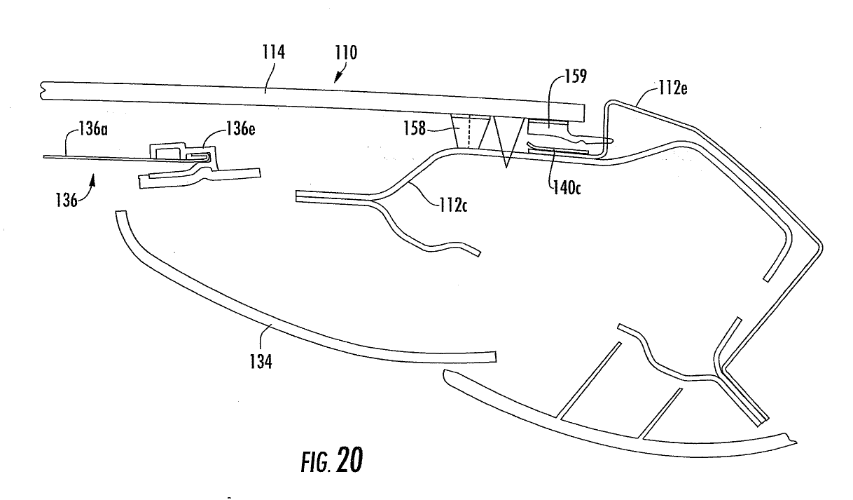

As best shown in FIGS. 16-20, roof panel 140 is attachable to the vehicle frame or sheet metal in a similar manner as described above with respect to roof panel 12d. Header portions 142, 144 provide raised header portions at the forward and rearward regions of the roof panel, and provide a recess or trough 143, 145, respectively, at their inboard regions (toward the central roof panel portion 146). The outboard regions or mounting portions 140a, 140b at the forward and rearward edges, respectively, of the roof panel 140 (and outboard of the respective header portions 142, 144) are at a lower level for attaching to the vehicle frame and for receiving the windshield and rear backlite thereat (as can be seen with respect to FIGS. 18 and 19). Optionally, and as shown in FIG. 18, a C-channel spacer or support or member 152 may be provided to attach and support trough portion 143 at reinforcement member 112a of vehicle 112. Similarly, the side mounting portions 140c of the side regions of roof panel 140 are at a lower level than the central panel portion 146 to facilitate attachment at the side reinforcement members 112c and/or the body side outer sheet metal 112e of the vehicle (such as can be seen in FIG. 20).

Accordingly, after the roof panel 140 is attached to the vehicle (such as via normal plant processing at the vehicle assembly plant), the vehicle may be painted and water tested with the other vehicles at the assembly plant. After the assembly process is completed, the completed vehicle (with the roof panel 140) may be transported to another facility or station (such as to an external provider or assembly facility or to another operator station at the vehicle assembly plant or to another facility of the vehicle manufacturer), whereby an operator may cut the temporary central roof panel portion 146 from the vehicle. As can be seen in FIGS. 18-20, the cut-line is preferably at or near the junction of the trough portions 143, 145 and the central panel portion 146 (such as at the base of the central panel portion) and along the side regions at or near the junction of the side mounting portions 140c and the central panel portion 146. If the cut line were closer to the header portions, there may be insufficient space for a proper adhesive bond between the glass roof panel and the trough or attachment region at the header portions.

After the central roof panel portion 146 is cut from or otherwise removed from the roof panel 140, the glass roof module 110 may be mounted to the header portions 142, 144 of roof panel 140 and to the side reinforcement members 112c of the vehicle. For example, and with reference to FIG. 18, the forward region of glass roof panel 114 may be attached or adhered to trough portion 143 (which may be supported by the member 152 at reinforcement member 112a), such as via adhesive or like, such as a urethane adhesive or the like. Optionally, a spacer member 154 may be provided between the glass surface and the trough portion 143 to provide the desired or appropriate spacing for the adhesive and/or to provide support for the glass panel 114. Optionally, a sealing element or seal 155 may be provided at the forward perimeter region of the glass panel for substantially sealing the glass panel 114 relative to the header portion 142 (or to the appliqué 148a, discussed below). Similarly, a sealing element 113c may be provided at the upper edge of the windshield 113a to substantially seal the windshield at the mounting portion 140a of the roof panel 140 and at the header portion 142 (and/or appliqué 148a discussed below).

In a similar manner, and with reference to FIG. 19, the rear perimeter region of the glass roof panel 114 may be attached or adhered to the trough portion 145 and generally at rear header portion 144. Optionally, a spacer member 156 may be provided between the glass surface and the trough portion 145 to provide the desired or appropriate spacing for the adhesive and/or to provide support for the glass panel 114. Optionally, a sealing element or seal 157 may be provided at the rearward perimeter region of the glass panel for substantially sealing the glass panel 114 relative to the header portion 144 (or to the appliqué 148b, discussed below).

Also, and with reference to FIG. 20, the side regions of the glass roof panel 114 may be attached or adhered to the side reinforcement member 112c of the vehicle (or optionally could be attached at or to the side mounting portion 140c of roof panel 140). Optionally, a spacer member 158 may be provided between the glass surface and the reinforcement member 112c to provide the desired or appropriate spacing for the adhesive and/or to provide support for the glass panel 114. Optionally, a sealing element or seal 159 may be provided at the side perimeter region of the glass panel for substantially sealing the glass panel 114 relative to the header portion side mounting portion 140c or to the body side outer sheet metal 112e of the vehicle, such as shown in FIG. 20.

Thus, the roof assembly or module 110 is mounted to the perimeter portions of the roof panel 140, with the header portions 142, 144 spanning the gaps between the forward edge of the glass roof panel 114 and the windshield 113a and the rearward edge of the glass roof panel 114 and the rear backlite 113b. The glass roof panel 114 thus may be substantially flush with the outer surface of the header portions 142, 144 and thus with the windshield and rear backlite, such that the glass roof module provides a substantially continuous exterior surface of the vehicle.

Optionally, and desirably, roof assembly or module 110 includes appliqués or trim elements 148a, 148b that are attached (such as via adhesive or tape or fasteners) to the respective header portions 142, 144 to provide the desired exterior appearance to the header portions. For example, the trim elements 148a, 148b may have a black and/or glossy surface finish to provide a desired contrast appearance at the header portions and between the windshield/backlite and glass roof panel. For example, a black or glossy black surface may be desired for the header portions, since the windshield and backlite and glass roof panel may have respective black or dark frit layers at their perimeter regions adjacent to the header portions. Such an appearance would be difficult to achieve without the appliqués or trim elements 148a, 148b, since the header portions and roof panel would be painted or coated/treated at the vehicle assembly plant with the rest of the vehicle frame or sheet metal at the vehicle assembly plant.

The appliqués or trim elements 148a, 148b may be attached to the header portions 142, 144 via any suitable attachment means. For example, the header portions 142, 144 may include guide elements or recesses or apertures 142a, 144a for engaging and guiding corresponding guide elements of the appliqués 148a, 148b to guide the appliqués to the appropriate location along the header portions. The appliqués and/or header portions may have an adhesive or tape or the like applied thereto to affix the appliqués to the header portions, or the appliqués may be attached or secured via any suitable fastener or fastening means, while remaining within the spirit and scope of the present invention.

As can be seen with reference to FIGS. 18 and 19, the exterior surfaces of the windshield 113a, appliqué 148a, glass roof panel 114, appliqué 148b and rear backlite 113b provide a substantially flush or continuous surface over the vehicle cabin, and thus provide an enhanced appearance to the vehicle. For applications where the appliqués may not be used, the header portions 142, 144 may be formed so as to project outward a sufficient amount such that the outer surfaces of the header portions are substantially flush with the outer surfaces of the glass roof panel and windshield/backlite.

Similar to the roof assemblies described above, roof assembly or module 110 may include a sun shade module 136 attached thereto (such as via fastener strips 150 as discussed above). The sun shade assembly 136 may comprise any suitable sun shade or screen assembly, and may utilize aspects of the shades or screens described in U.S. patent application Ser. No. 11/243,783, filed Oct. 5, 2005 by Dubay et al. for WINDOW AND SUN SHADE MODULE FOR VEHICLE, and published Apr. 20, 2006 as U.S. Publication No. US-2006-0082192-A1, which is hereby incorporated herein by reference in its entirety. Sun shade module 136 includes a shade or screen 136a that is extendable from and retractable into a spool 136b. Optionally, the screen 136a may have a handle portion 136c for a user to grasp and pull so as to extend the screen along the underside of the glass roof panel 114. As shown in FIG. 18, the handle portion 136c may releasably attach to a clasp 136d to retain the screen 136a in its extended position. The spool 136b may be biased to retract the screen so that when the handle portion 136c is released from the clasp 136d, the screen is retracted into the spool for storage when not in use. The sun shade module 136 includes side tracks 136e along the side regions of the glass roof panel 114, so that the screen is guided along and retained along the interior or lower surface of the glass roof panel 114 when extended or partially extended.

Roof module 110 also includes a perimeter headliner 134 that is attached at the interior perimeter regions of the vehicle and roof module. Headliner 134 functions to substantially cover or conceal the vehicle sheet metal or frame and the spool 136b and side tracks or channels 136e of the sun shade module 136, so as to provide an aesthetically pleasing interior roof of the vehicle cabin. The headliner may be attached, such as via fasteners or snap-connectors or the like, to the vehicle and/or roof module after the roof module is mounted at the header portions and side regions of the roof portion of the vehicle.

Thus, the roof module 110 provides an enhanced assembly process at the vehicle assembly plant, and allows for the installation of the roof module by an external provider after the vehicle is completely assembled and painted and tested. Because the vehicle manufacturer knows at the time of assembly which vehicles are designated to have a glass roof module installed thereon, the vehicle manufacturer can readily have the appropriate, special roof panel or portion (with the temporary center panel portion) installed on those vehicles. The vehicles thus may be assembled and painted/coated and tested with the other vehicles, since no other special processes are required for the vehicles designated for the glass roof module or vista roof. The assembled designated vehicles may then be shipped to an external provider (or otherwise moved or transported to an external provider or to another location, such as another operator or station at the vehicle assembly plant or to another facility), where the center roof panel is cut away and the glass roof module is installed. The header portions and troughs are thus part of the vehicle as it leaves the assembly line or assembly plant and are not separately installed or attached to the vehicle by the external provider (or at another location or station at the vehicle assembly plant or at another facility of the vehicle manufacturer or the like).

The special roof portion thus provides a custom made receptacle for the glass roof module, whereby the external provider cuts away the center roof panel or portion and lays in and installs the glass roof module, which is substantially flush with the header portions or appliqués when so installed. The present invention thus avoids some of the difficulties with other glass roof modules, such as having to cut away the entire roof and mounting the glass directly onto the vehicle frame or sheet metal. By providing the headers and troughs at the roof portion, the headers and troughs provide a mounting area for receiving the glass module in that is separated from the upper edge of the glass windshield or backlite (which is desirable since close proximity of the glass roof to the sheet metal and/or windshield/backlight may lead to glass breakage).

Therefore, the present invention provides a method of providing a glass roof module at a vehicle that includes assembling the vehicle at a vehicle assembly plant. The assembly of the vehicle includes installing or attaching a roof portion that is adapted to provide a perimeter mounting portion or halo for mounting the glass roof module thereto. The adapted roof portion includes a front header portion and a rear header portion and a glass panel mounting portion or trough at each header portion. The assembled vehicle, with the roof portion attached thereto, is water tested at the vehicle assembly plant and then transported to an external provider for installing the glass roof module. The external provider cuts or removes a center roof panel at or near the mounting portions or troughs. The glass roof panel is set onto the mounting portions or troughs and attached or adhered thereto. Although described as being accomplished by an external provider, the steps of cutting and removing the center roof panel and installing the glass roof module may be performed by the vehicle manufacturer, such as at the vehicle assembly line or vehicle assembly plant or at another facility of the vehicle manufacturer, or may be performed by an external provider or supplier or assembler, such as at a remote facility or at the vehicle assembly plant or the like, while remaining within the spirit and scope of the present invention.

Optionally, one or more appliqués or trim elements may be provided to cover the header portions to provide the desired appearance of the vehicle. Optionally, the vehicle may be water tested after completion of the installation of the glass roof module. Optionally, the glass roof module may include a sun shade module or assembly at an interior portion of the glass roof panel. Optionally, a perimeter headliner may be attached to the glass roof module and/or the vehicle to substantially cover and conceal the vehicle sheet metal and frame and the spool and guide tracks of the sun shade module.

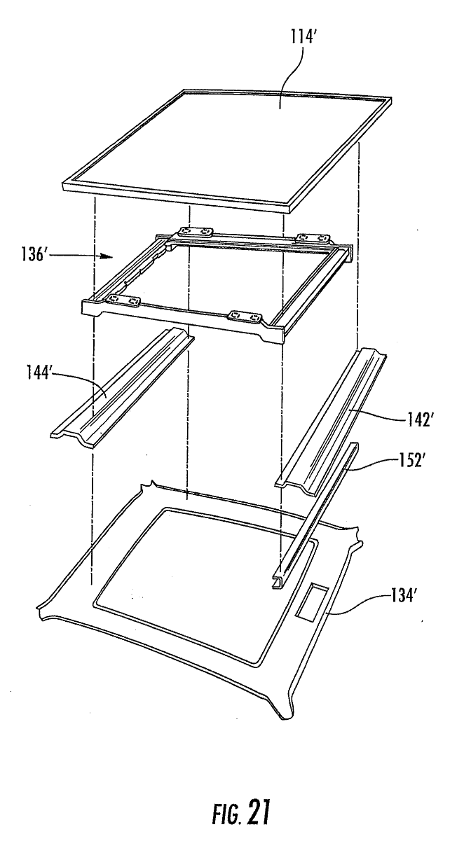

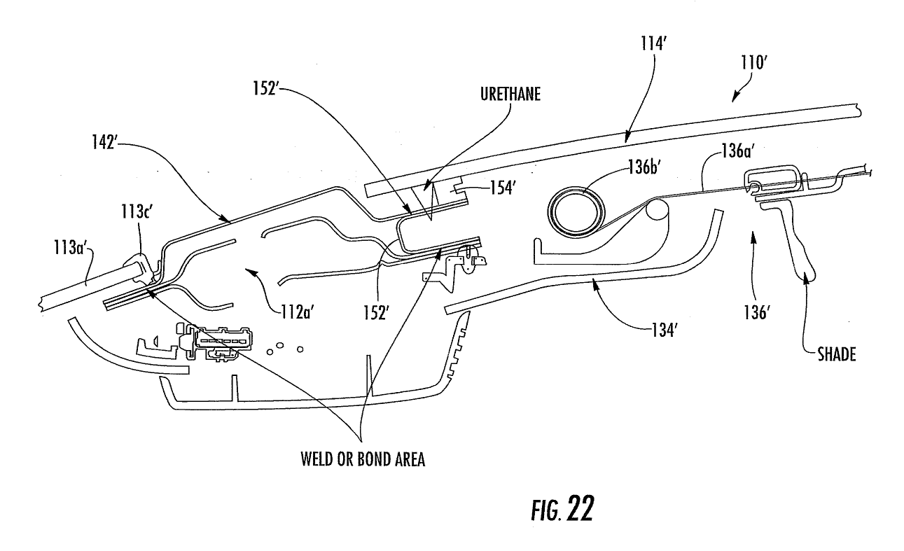

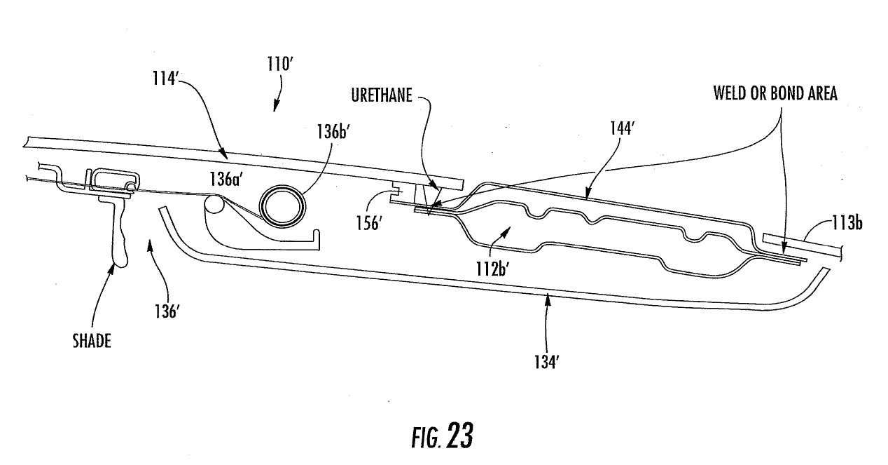

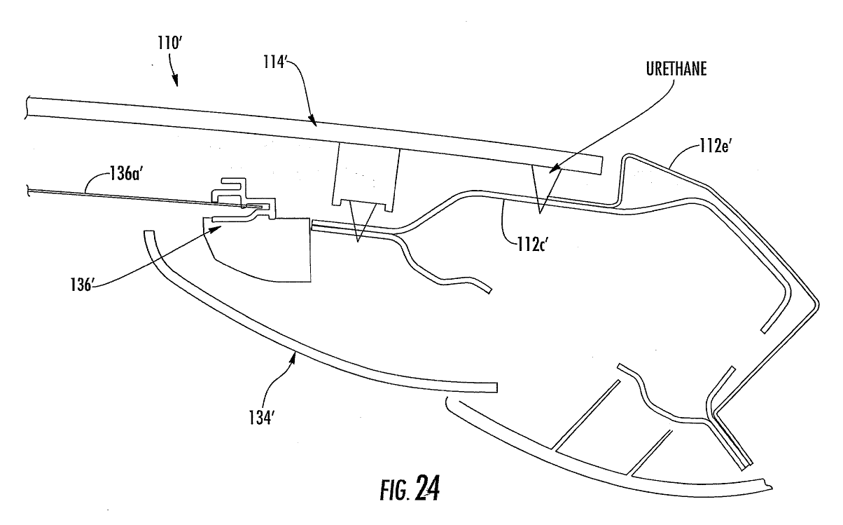

Optionally, a glass roof assembly or module of the present invention may be mounted to front and rear header portions that are separately attached to the vehicle frame or sheet metal, and not attached as part of a roof portion having a temporary roof panel as described above. For example, and with reference to FIGS. 21-24, a glass roof assembly or module 110′ is mounted to a front header portion 142′ and a rear header portion 144′ that are separately attached to the vehicle frame or sheet metal or reinforcement members 112a′, 112b′. As shown in FIG. 22, the front header portion 142′ may be attached at its forward end 142a′ to the reinforcement member 112a′ and may be attached to a C-channel reinforcement member 152 that is attached to the header reinforcement 112a′, and the roof module 110′ may have a reinforcement member or support member 154′ and/or a sealing member 155′ disposed between the glass panel 114′ and the header 142′, such as in a similar manner as described above. Also, rear header portion 144′ may be attached to the rear reinforcement member 112b′, and the roof module 110′ may have a reinforcement member or support member 156′ and/or a sealing member 157′ disposed between the glass panel 114′ and the rear header 144′, such as in a similar manner as described above. The side regions of the glass panel 114′ may be attached or adhered to the side reinforcement member 112c′ and/or the body side outer sheet metal 112e′ of the vehicle.

Also similar to glass roof module 110, discussed above, the glass roof module 110′ may include a sun shade module 136′, which may be fastened or attached or adhered to the lower or inner surface of glass roof panel 114′. A new perimeter headliner portion 134′ may be provided at the forward, rearward and side regions to cover or conceal the perimeter regions of the roof module 110′ and/or sun shade module or assembly 136′. As shown in FIG. 21, the headliner portion 134′ may comprise a continuous perimeter headliner portion at the underside of the roof module, but it is envisioned that separate front, rear and/or side portions may be provided without affecting the scope of the present invention.

Thus, the glass roof module 110′ provides a roof module that is similar to glass roof module 110, discussed above, yet has separate header portions attached to the vehicle frame or sheet metal or reinforcement members. Although the glass roof module 110′ may provide a flush continuous glass paneling over the vehicle cabin, glass roof module 110′ does not facilitate the completion of the assembly of the vehicle and painting/coating of the vehicle and water testing of the vehicle at the vehicle assembly plant, since no roof panel is provided.

Optionally, the sun shade assemblies of the glass roof modules of the present invention provide a sun shade that may be extended under the glass roof panel to shade the interior of the vehicle, and that may be retracted (such as within a spool or roller) to allow for visibility and viewing through the glass panel. The sun shade assembly may include two shades or screens (such as shown in FIGS. 5-6, 8-9 and 22-23) that are retractable into their respective rollers, where a roller may be located at a rearward portion or region of the roof module and another roller may be located at the forward portion or region of the roof module. Optionally, the sun shade assembly or module may include a single screen that is retracted into a single spool, with the spool being located at either the front portion of the vehicle glass roof module or at the rear portion of the glass roof module, such as shown in FIGS. 12, 13 and 19. The sun shade assembly 18 may comprise any suitable sun shade or screen assembly, and may utilize aspects of the shades or screens described in U.S. patent application Ser. No. 11/243,783, filed Oct. 5, 2005 by Dubay et al. for WINDOW AND SUN SHADE MODULE FOR VEHICLE, and published Apr. 20, 2006 as U.S. Publication No. US-2006-0082192-A1, which is hereby incorporated herein by reference in its entirety.

Optionally, the sun shade module may be bonded to the glass roof panel or may be otherwise attached or fastened to the glass roof panel, such as via attachment strips or the like. The sun shade module may comprise a one piece design (with a single screen and roller or spool) or a two piece design (with a screen and spool at opposite ends of the sun shade module), or other designs depending on the particular application of the glass roof module. The two piece or two screen design provides a more ergonomic pulling distance, and may allow the spool to have a reduced spring retrieve pressure, which may prolong the life of the damper and may reduce noise during extension/retraction of the screen. However, the one piece or one screen design may expose less sunlight due to only one pull bar instead of two pull bars. Optionally, and desirably, a single spool sun shade module may be provided with the spool at the rear portion of the glass roof module (as shown with respect to glass roof module 110), where the user may reach back to grasp the handle of the sun shade to pull it forward to shade the vehicle cabin. Such a sun shade may be preferred for smaller vehicles, where the rearward reach may be readily accomplished. Such a sun shade also provides a larger glass area of the glass roof module at the forward end of the glass roof module, since the forward region of the sun shade module would not have a spool thereat.

Optionally, the glass panel may comprise a tinted glass panel and/or a coated glass panel to reduce transmission of solar energy therethrough. For example, the glass panel may include a SUNGATE® coating (such as is available from PPG Industries, Inc. of Pittsburgh, Pa.), which may be disposed between a clear glass panel (such as a 2.1 mm thick clear glass panel) and a tinted privacy glass panel (such as a 2.1 mm privacy glass panel), and optionally with a layer of pigmented VINYL (such as a 0.76 mm (or thereabouts) pigmented 44 percent LTA VINYL layer). Such a glass assembly may reduce infrared energy transmission by about 50 percent, and may reduce vehicle cool-down time by about 50 percent and thus reduce the amount of work required by the vehicle air conditioner by about 20 percent and thus may increase fuel economy. Such a glass assembly thus may provide more comfortable driving conditions and may protect the interior fabric materials from deterioration and discoloration often caused by prolonged exposure to solar radiation. The tint or color of the glass assembly may be selected to match the automotive side and rear glass or may be colored as desired.

The frame portion of the roof modules or assemblies of the present invention may comprise any suitable material, and may comprise a polymeric or plastic frame portion, such as a PVC frame portion that provides an encapsulation of the upper and side perimeter portions of the glass roof panel. The frame portion may be formed utilizing aspects of the frame portions or encapsulated window modules of the types described in U.S. Pat. Nos. 6,669,267; 6,729,674; 6,572,176; 6,394,529; 6,299,235; 6,220,650, which are hereby incorporated herein by reference.

The glass panel may be bonded or secured to the frame or header portions and the frame and/or header portions may be bonded or secured to the vehicle sheet metal and/or the sun shade module or attachment elements may be bonded or secured to the glass panel via any suitable bonding material or adhesive, such as a butyl seal and/or a urethane or the like, such as via curing of a bonding or an adhesive material and utilizing bonding processes of the types described in U.S. Pat. Nos. 6,298,606; 6,128,860; 5,966,874; 5,704,173; and 5,551,197, which are hereby incorporated herein by reference in their entireties. For example, the glass roof panel may be bonded to the headers by an adhesive, such as a urethane adhesive, including a one part or two part urethane adhesive, an epoxy adhesive, an acrylic adhesive, a polyvinylbutyral adhesive, a silicone adhesive, or the like. Reference is made to U.S. Pat. Nos. 4,364,214; 4,364,595; 6,299,255; and 6,220,650, which are incorporated by reference in their entireties, for examples of suitable adhesives. Optionally, and desirably, the glass roof panel may include a frit layer at the perimeter regions that is substantially opaque (such as a dark color or black) and, therefore, provides a concealing function and may further facilitate the adhesion or bonding of the panel to the frame or header portions.

Therefore, the present invention provides an integrated glass roof module that allows ease of assembly with enhanced aesthetic appearance and enhanced solar performance. The roof module includes full periphery molding that provides a water tight seal so that the attachment joints are substantially water impervious, and hides the metal joint/weld areas. The roof module may have a drip mold detail that allows for weld and water management. The roof module thus provides an encapsulated glass and shade module that may be readily attached to a vehicle, such as at a cut existing roof (such as for aftermarket applications) or such as at the upper regions of the vehicle windshield and backlite (such as where no roof has been attached to the vehicle at the vehicle assembly plant).

Changes and modifications to the specifically described embodiments may be carried out without departing from the principles of the present invention, which is intended to be limited only by the scope of the appended claims, as interpreted according to the principles of patent law.

1: A method of providing a glass roof module at a vehicle, said method comprising:
assembling a vehicle at a vehicle assembly plant, said assembling the vehicle comprises attaching a roof portion that is adapted to provide a perimeter mounting portion or halo for mounting said glass roof module thereto, said adapted roof portion comprising a front header portion and a rear header portion and a glass panel mounting portion or trough at each of said header portions;
water testing said assembled vehicle at the vehicle assembly plant, said assembled vehicle having said roof portion attached thereto;
removing a center roof panel portion of said roof portion by cutting said roof portion at or near said mounting portions or troughs;
providing a glass roof module having a glass roof panel; and
setting said glass roof panel onto said mounting portions or troughs and attaching said glass roof panel to said mounting portions or troughs.

2: The method of claim 1 further comprising attaching one or more appliqués or trim elements to said header portions.

3: The method of claim 1 further comprising water testing the vehicle after completion of the installation of said glass roof module.

4: The method of claim 1, wherein providing a glass roof module comprises providing a glass roof module having a sun shade module or assembly at an interior portion of said glass roof panel.

5: The method of claim 1 further comprising attaching a perimeter headliner at an interior portion of said glass roof module and/or the vehicle.

6: The method of claim 1 further comprising transporting said assembled vehicle to an external provider for installing said glass roof module.

7: A glass roof system for use in a vehicle, said system comprising:
a glass roof panel, said glass roof panel having an inner surface and an outer surface;
a front header member and a rear header member, said front header member being mountable to a vehicle reinforcement member at an upper region of the vehicle windshield and said rear header member being mountable to a vehicle reinforcement member at an upper region of the vehicle backlite;
a forward region of said inner surface of said glass roof panel being adhered to said front header member and a rearward region of said inner surface of said glass roof panel being adhered to said rear header member; and
wherein said glass roof panel substantially spans a gap between the vehicle windshield and the vehicle backlite to provide substantially continuous glass panels, including the vehicle windshield, said glass roof panel and the vehicle backlite, along the cabin of the vehicle.

8: The glass roof system of claim 7, wherein said front header member is bonded to an inner surface of said glass roof panel and is attached to the vehicle reinforcement member at the upper region of the vehicle windshield to secure a forward region of said glass roof panel to the vehicle.

9: The glass roof system of claim 8, wherein said rear header member is bonded to said inner surface of said glass roof panel and is attached to the vehicle reinforcement member at the upper region of the vehicle backlite to secure a rearward region of said glass roof panel to the vehicle.

10: The glass roof system of claim 9 further comprising side members for attaching respective side regions of said glass roof panel to respective side reinforcement members of the vehicle.

11: The glass roof system of claim 10, wherein said glass roof panel is attached to the vehicle via said front and rear header members and said side member to space said glass roof panel from the respective reinforcement members to limit glass breakage during use and operation of the vehicle.

12: The glass roof system of claim 7, wherein said glass roof panel has a dark frit layer disposed at said inner surface and at least at said forward and rearward regions of said glass roof panel, said forward and rearward regions of said inner surface of said glass roof panel being adhered to said respective header members at said dark frit layers.

13: The glass roof system of claim 7, wherein said glass roof panel and said front and rear header members are adapted to be received in an opening formed through an existing vehicle roof of the manufactured vehicle.

14: The glass roof system of claim 7 further comprising a sun-shade module that is disposed generally at said inner surface of said glass roof panel and that is selectively adjustable to extend and retract an at least partially opaque panel to at least partially shade said glass roof panel.

15: The glass roof system of claim 7, wherein said front and rear header members are configured to span respective gaps between said glass roof panel and the respective one of the vehicle windshield and the vehicle backlite.

16: The glass roof system of claim 7 further comprising at least one appliqué at least one of said front and rear header members.

17: The glass roof system of claim 7, wherein said outer surface of said glass roof panel at said forward region is generally flush with the upper region of the vehicle windshield and said outer surface of said glass roof panel at said rearward region is generally flush with the upper region of the vehicle backlite when said glass roof panel is adhered to said front and rear header members and when said front and rear header members are attached to the vehicle reinforcement members.

18: A glass roof system for use in a vehicle, said system comprising:
a glass roof panel, said glass roof panel having an inner surface and an outer surface;
a front header member and a rear header member, said front header member being mountable to a vehicle reinforcement member at an upper region of the vehicle windshield and said rear header member being mountable to a vehicle reinforcement member at an upper region of the vehicle backlite;
a forward region of said inner surface of said glass roof panel being adhered to said front header member and a rearward region of said inner surface of said glass roof panel being adhered to said rear header member;
wherein said glass roof panel substantially spans a gap between the vehicle windshield and the vehicle backlite to provide substantially continuous glass panels, including the vehicle windshield, said glass roof panel and the vehicle backlite, along the cabin of the vehicle;
wherein said glass roof panel has a dark frit layer disposed at said inner surface and at least at said forward and rearward regions of said glass roof panel;
wherein said front header member is bonded to a forward region of said inner surface of said glass roof panel and at said frit layer and said front header member is attached to the vehicle reinforcement member at the upper region of the vehicle windshield to secure a forward region of said glass roof panel to the vehicle; and
wherein said rear header member is bonded to a rearward region of said inner surface of said glass roof panel and at said frit layer and said rear header member is attached to the vehicle reinforcement member at the upper region of the vehicle backlite to secure a rearward region of said glass roof panel to the vehicle.

19: The glass roof system of claim 18 further comprising side members for attaching respective side regions of said glass roof panel to respective side reinforcement members of the vehicle.

20: The glass roof system of claim 18 further comprising a sun-shade module that is disposed generally at said inner surface of said glass roof panel and that is selectively adjustable to extend and retract an at least partially opaque panel to at least partially shade said glass roof panel.

21: The glass roof system of claim 18 further comprising at least one appliqué at least one of said front and rear header members.
